(19) United States
(12) Patent Application Publication
(10) Pub. No.: US 2008/0020172 A1
(43) Pub. Date: Jan. 24, 2008

(54) Wrapped panel construction for improved void filler product

(75) Inventor: George C. Boyse, Rocklin, CA (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: Greif International Holding B.V.

(21) Appl. No.: 11/490,250

(22) Filed: Jul. 21, 2006

(51) Int. Cl. B32B 3/00

(52) U.S. Cl. 428/71; 428/74; 428/316.6; 428/157; 428/167

(57) ABSTRACT

A wrapped panel includes a core material and a one-piece sheet. The core material having rows of collapsible and expandable cells, wherein the rows of cells having a variable dimension as the rows are manipulated between collapsed and expended conditions. The one-piece sheet having a body portion, two integrally formed side wall portions extending from the body portion, and two integrally formed end portions extending from the two side wall portions, the sheet being wrapped around the core material.

### FIELD OF THE INVENTION

The present invention relates generally to shipping containers, such as trailers and railcars, and products shipped in them. More particularly, the present invention relates to panels used in conjunction with void filler.

### BACKGROUND OF THE INVENTION

When transporting goods in freight containers, care needs to be taken to fill up the unused storage space between loads to avoid shifting of the loads. Traditionally, expandable dunnage devices are used to fill up these spaces between the loads. For example, U.S. Pat. No. 4,585,381 teaches the use of expandable honeycomb-type void fillers to fill the void areas in vehicles. However, these dunnage devices can be distorted and collapsed during transportation.

Efforts were made to overcome this problem and corrugated panels were introduced to the industry. These corrugated panels are usually made with a top deck sheet, a bottom deck sheet, and a core material between the sheets. These corrugated panels mitigate the collapse problem of the honeycomb-type void filler, however, the panels have poor resistance to bending and wear and tear that does not allow for reuse. For example, U.S. Pat. No. 4,865,889 teaches the use of outer sheets with a series of inner core sheets to create an expandable void filler. The problem with this type of corrugated panel is that the deck sheets only stabilize the core sheets and do not provide strength to the overall structure of the panel. Therefore, during transportation, these corrugated panels can be damaged when subjected to additional stresses other than just compression.

Wrapped deck pallets are also utilized in the shipping industry. For example, U.S. Pat. No. 5,465,672 teaches a deck pallet wrapped in an envelope. The deck pallet includes paper board decks that sandwich a plurality of blocks. Due to the various elements in this type of wrapped deck panel, the construction is cumbersome.

Other void filler and deck pallets that have attempted to solve these problems for shipping purposes are shown in the following U.S. Pat. Nos. 5,062,751; 5,171,114; 5,139,842; 5,595,125; 5,921,187; 6,357,364; 6,915,747.

Therefore, there exists a problem with the shipping industry where shipping panels and void filling mechanisms are unable to sustain bending force during transportation and are easily damaged.

It is desirable therefore to provide a panel that is simple in its design that overcomes the deficiencies of the poor crush strength and collapsibility of the prior art void fillers. It would also be desirable to provide a panel that utilizes existing materials and adds strength to the panel to resist bending force. It is also desirable to provide a panel that is durable and has extended usage.

Accordingly, it is desirable to provide a strong and durable panel for shipping containers and products and a method for making the same.

### SUMMARY OF THE INVENTION

The foregoing needs are met, to a great extent, by the present invention, wherein in one aspect an apparatus is provided that in some embodiments includes a wrapped panel that provides additional strength and durability to the void filler.

In accordance with one embodiment of the present invention, a wrapped panel is provided, and includes a core material and a one-piece sheet. The core material includes rows of collapsible and expandable cells. The rows of cells have a variable dimension as the rows are manipulated between collapsed and expanded conditions. The one-piece sheet includes a body portion, two integrally formed side wall portions extending from the body portion, and two integrally formed end portions extending from the two side wall portions. The one-piece sheet is wrapped around the core material.

In accordance with another aspect of the present invention, a method for forming a wrapped panel is provided, which includes forming a u-shaped element from a blank, the u-shaped element forming a base, two side walls extending from the base and two end portions extending from the side walls. A core material is affixed on the base of the u-shaped element. The two end portions are folded over the core material, thereby creating a rigid wrapped panel. The core material includes rows of collapsible and expandable cells, wherein the rows of cells have a variable dimension as the rows are manipulated between collapsed and expanded conditions. A reinforcement material is disposed within the u-shaped element to provide additional rigidity to the wrapped panel. And a deck layer is disposed between the core material and the two end portions of the u-shaped element.

In accordance with yet another embodiment of the present invention, a wrapped panel is provided, including a core material having rows of collapsible and expandable cells, and a one-piece sheet wrapped around the core material. The rows of cells have a variable dimension as the rows are manipulated between collapsed and expanded conditions.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective view illustrating a prior art panel.

FIG. 2 is a side view of the prior art panel of FIG. 1.

FIG. 3 is a perspective view illustrating a wrap-around panel of the present invention in assembled form.

FIG. 4 is a side view of the wrap-around panel of the present invention of FIG. 3 as it is being assembled.

FIG. 5A illustrates the bending strength of the prior art panel.

FIG. 5B is a cross-sectional view taken along the 2-2 in FIG. 3, and does not show the void filler in order to illustrate the channel and rectangular edge formed by the wrap-around panel.

FIG. 6 is an alternative embodiment of the present invention.

FIG. 7 illustrates the wrap-around panel with deck layers as reinforcement material.

FIG. 8 is another alternative embodiment of the present invention.

### DETAILED DESCRIPTION

The invention will now be described with reference to the drawing figures, in which like reference numerals refer to like parts throughout. An embodiment in accordance with the present invention provides a wrap-around panel with void filler that provides strength and durability to void fillers used in shipping and palletized shipping containers.

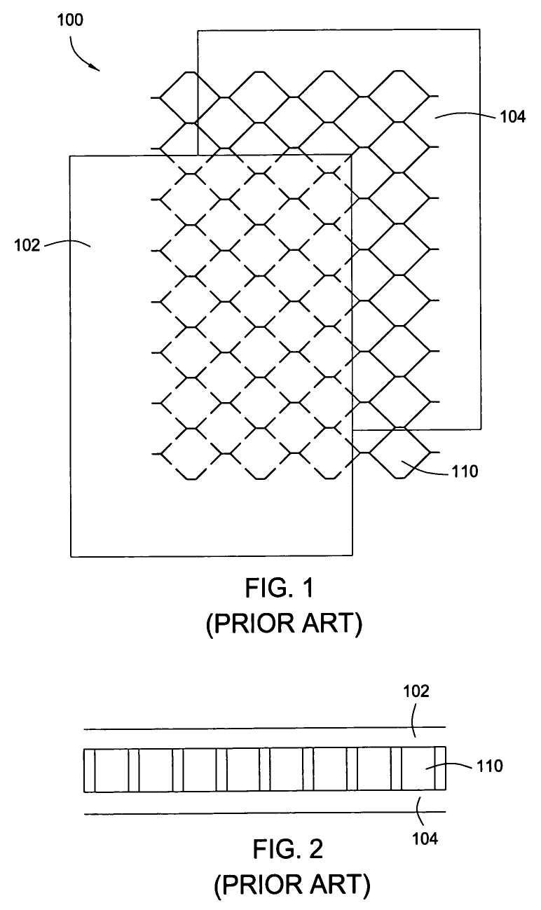

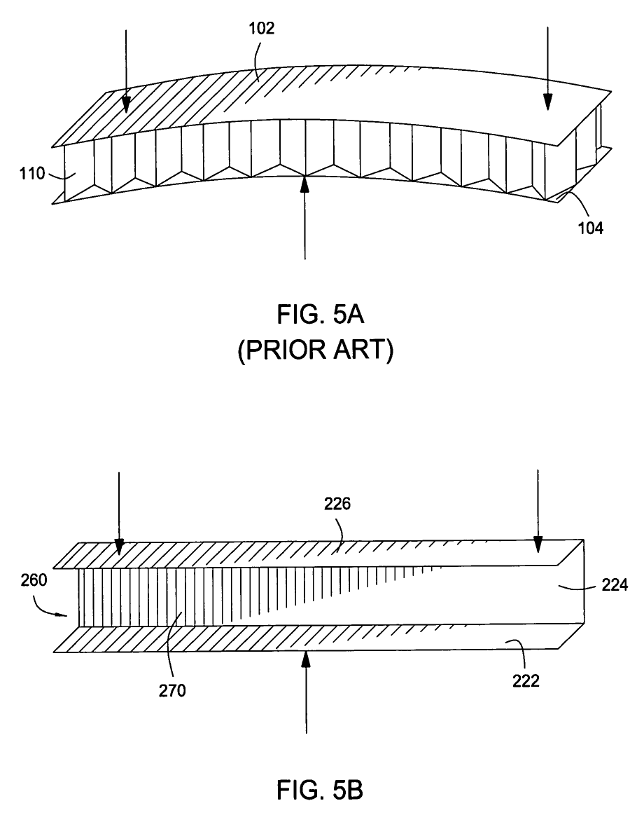

As illustrated in FIGS. 1 and 2, the prior art panel 100 has a core material 110 placed between the top 102 and bottom 104 sheets. The top 102 and bottom 104 sheets only stabilize the core material 110 and do not provide strength to the panel 100. Therefore, the prior art panel 100 has limited strength when subject to bending as illustrated in FIG. 5A. Continuous bending of the panel causes the bond between the sheets 102, 104 and the core materials 110 to be weakened. Furthermore, the edges of the sheets 102, 104 are easily damaged and can contribute to delaminating of the sheets from the core.

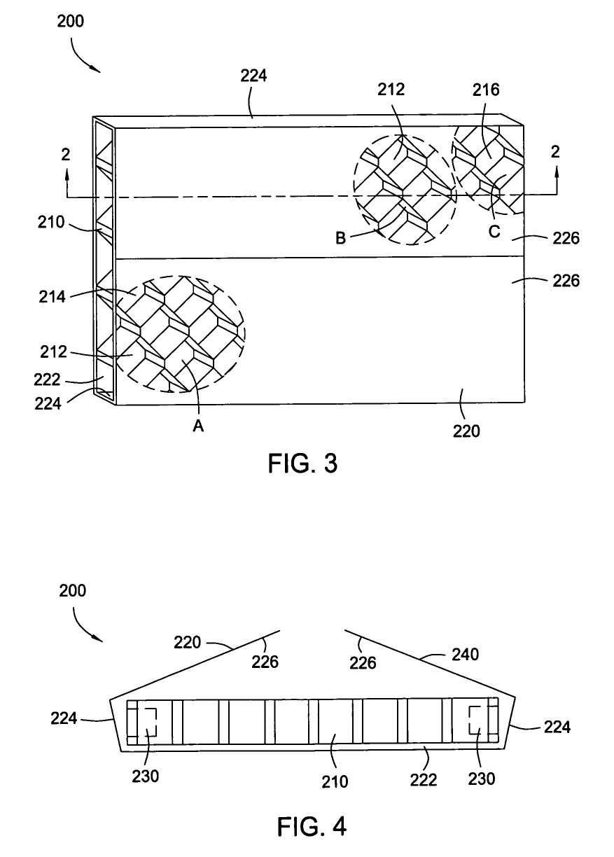

In comparison, an embodiment of the present invention wrap-around panel 200 as illustrated in FIG. 3 overcomes the disadvantages of the prior art panel 100. The wrap-around panel 200 has a core material portion 210 and a one-piece sheet 220. The one-piece sheet 220 is shown partially cut-away with regions A, B, and C to illustrate the cells arrangements of the core material 210.

The core material 210 can include rows of collapsible and expandable cells 212 as shown in cutaway regions A, B, and C. The rows of cells can have variable dimensions as the rows are manipulated between collapsed and expanded conditions. Each row may include first end 214 and second end 216 cells as shown in regions A and C. Examples of such collapsible and expandable cells can be found in U.S. Pat. Nos. 4,585,381 and 4,865,889, which are incorporated by reference in their entirety.

As illustrated in FIG. 4, the one-piece sheet 220 includes a body portion 222, two integrally formed side wall portions 224 extending from the body portion 222, and two integrally formed end portions 226 extending from the two side wall portions 224. Upon wrapping around the core material 210, the end portions 226 are secured to define a substantially flat surface. Thus, unlike the prior art panel, the end portions 226 are not easily damaged. Therefore, the present design extends the usage of the wrap-panel 200.

The one-piece sheet 220 is wrapped around the core material 210. A u-shaped element 240 is formed from the one-piece sheet 220. The u-shaped element includes a body portion 222, two side wall portions 224 extending from the body portion 222, and two end portions 226 extending from the two side wall portions 226. The core material 210 is placed on top of the body portion 222 and the side wall portions 224 and the end portions 226 are folded over the core material 210. The core material 210 can be glued on to the u-shaped element 240. Thus, the u-shaped element wraps around the core material 210 creating a rigid wrapped panel 200.

In addition, reinforcement materials 230 can also be placed between the core material 210 and the u-shaped element 240 to provide additional strength and rigidity to the wrapped panel.

FIG. 5B is a cross-sectional view taken along the 2-2 in FIG. 3. It illustrates the bending strength of the wrap-around panel of the present invention. One of the advantages of using a one-piece sheet is the formation of a channel 260 between the sides of the wrapped panel which is formed by the rectangular edge 270 formed by body portion 222, side wall 224, and end portion 226. This design adds strength and resistance to bending. Thus, the present invention provides a panel with strength and durability.

The core material 210 can be Dor-Kor® void filler, collapsible void filler, honeycombed void filler, foam products, or multi-ply structure fillers. The one-piece sheet 220 can be corrugated paperboard or other substitutable materials. Furthermore, the one-piece sheet 220 can be made from many different test weights of corrugated paperboard. Each chosen for the strength and durability desired for the customers' application. Similarly, the core material 210 can be made from various materials to provide the desired strength and durability needed by the customer.

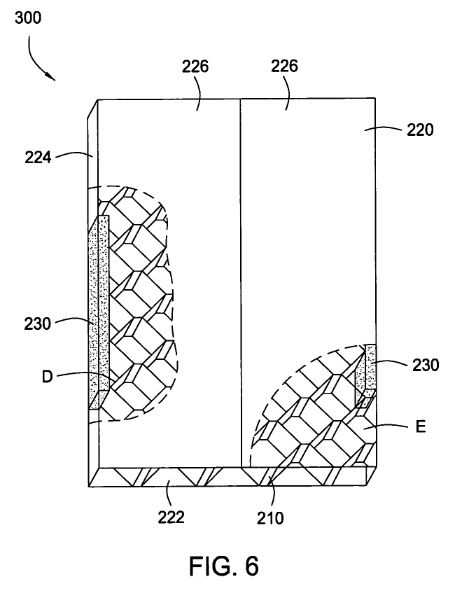

The wrap-around panel 200 may also include reinforcement materials 230 to add strength to the overall structure of the wrapped panel. FIG. 6 illustrates an alternative embodiment 300 of the invention. The one-piece sheet 220 is shown partially cut-away with regions D and E to illustrate the cells as arranged with the reinforcement material 230. The wrap-around panel 300 can include reinforcement materials 230 such as a rolled tube, fiber strip, corrugated buildups, or fiber sheets. These reinforcement materials 230 may be disposed along any length of the side wall portion 224 of the one-piece sheet.

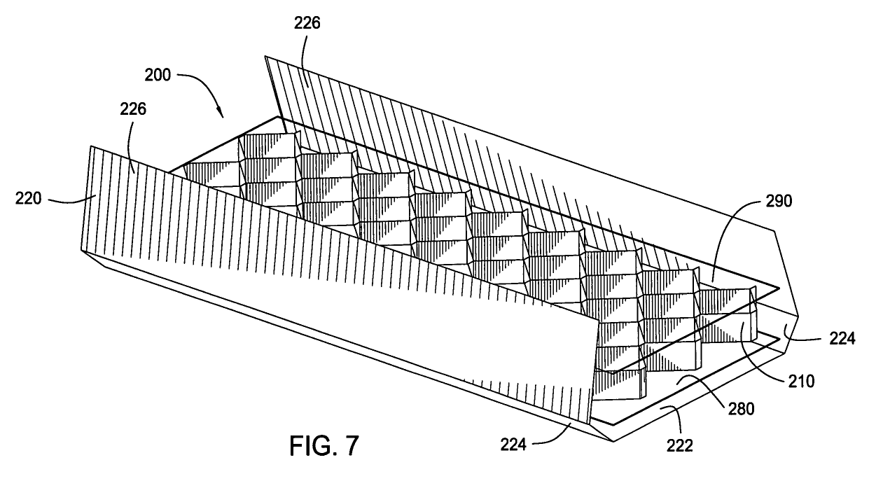

In the alternative, the reinforcement material can be deck layers 280, 290 as illustrated in FIG. 7. The deck layers 280 and 290 are shown as transparent so that one can better visualize the invention. The top deck layer 290 and the bottom deck layer 280 sandwich the core material 210 as shown. For example, the bottom deck layer 280 can be placed between the core material 210 and the body portion 222 of the sheet 220 and the top deck layer 290 can be placed between the core material 210 and the end portions 226. Hence, the deck layers 280, 290 provide additional strength to the wrap-around panel. It is noted that the customer may use one or both deck layers depending on his needs.

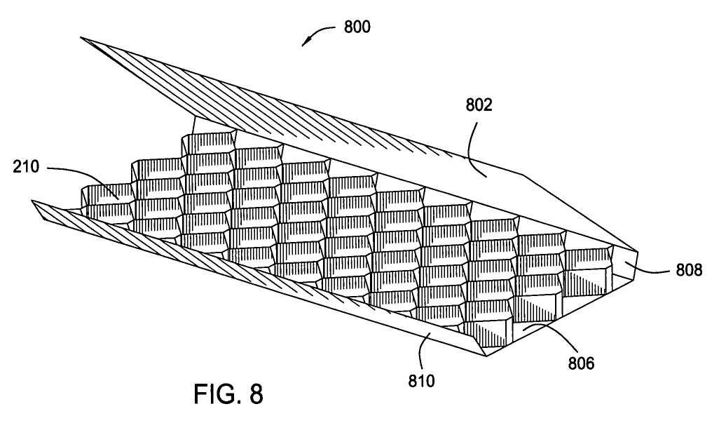

In another embodiment 800 of the present invention according to FIG. 8, the one-piece sheet can include two body portions 802, 806, and two side wall portions 808, 810. The body portion 802 extends from side wall portion 808. The body portion 806 is between the two side wall portions 808, 810. The core material 210 is placed on top of the body portion 806 as shown in FIG. 8. The side wall portions 808, 810 and the body portion 802 are wrapped around the core material 210 creating a rigid wrapped panel. The body portion 802 and the side wall portion 810 can be joint using tape or other materials to fold over and secure the two portions.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A wrapped panel, comprising:
a core material having rows of collapsible and expandable cells, wherein the rows of cells have a variable dimension as the rows are manipulated between collapsed and expanded conditions; and
a one-piece sheet having a body portion, two integrally formed side wall portions extending from the body portion, and two integrally formed end portions extending from the two side wall portions, the sheet being wrapped around the core material.

2. The wrapped panel of claim 1, further comprising reinforcement material disposed within the sheet.

3. The wrapped panel of claim 2, wherein the reinforcement material is a rolled tube, fiber strip, corrugated buildups, or fiber sheets.

4. The wrapped panel of claim 2, wherein the reinforcement material is disposed along the side wall portions of the sheet.

5. The wrapped panel of claim 1, wherein the end portions are secured to the core material to define a substantially flat surface.

6. The wrapped panel of claim 1, further comprising a deck layer between the core material and the sheet.

7. The wrapped panel of claim 1, wherein the core material is Dor-Kor® void filler, collapsible void filler, honeycombed void filler, foam products, or multi-ply structure fillers.

8. The wrapped panel of claim 1, wherein the sheet is a corrugated card board.

9. A method for forming a wrapped panel, the steps comprising:
forming a u-shaped element from a blank, the u-shaped element forming a base, two side walls extending from the base and two end portions extending from the side walls;
affixing a core material on the base of the u-shaped element, wherein the core material includes rows of collapsible and expandable cells, wherein the rows of cells have a variable dimension as the rows are manipulated between collapsed and expanded conditions; and
folding the two end portions over the core material, thereby creating a rigid wrapped panel.

10. The method of claim 9, further comprising disposing a reinforcement material within the u-shaped element to provide additional rigidity to the wrapped panel.

11. The method of claim 10, wherein the reinforcement material is disposed along the side walls of the u-shaped element.

12. The method of claim 9, further comprising disposing a deck layer between the core material and the two end portions of the u-shaped element.

13. A wrapped panel, comprising:
a core material having rows of collapsible and expandable cells, wherein the rows of cells having a variable dimension as the rows are manipulated between collapsed and expanded conditions; and
a one-piece sheet wrapped around the core material.

14. The wrapped panel of claim 13, further comprising reinforcement material disposed within the one-piece sheet to provide additional rigidity to the wrapped panel.

15. The wrapped panel of claim 14, wherein the reinforcement material is a rolled tube, fiber strip, corrugated buildups, or fiber sheets.

16. The wrapped panel of claim 14, wherein the reinforcement material is disposed between the one-piece sheet and the core material to provide additional rigidity to the wrapped panel.

17. The wrapped panel of claim 13, further comprising a deck layer attached between the core material and the one-piece sheet.

18. The wrapped panel of claim 13, wherein the core material is Dor-Kor® void filler, collapsible void filler, honeycombed void filler, foam products, or multi-ply structure fillers.
